(19) United States
(12) Patent Application Publication
(10) Pub. No.: US 2009/0205818 A1
(43) Pub. Date: Aug. 20, 2009

(54) DOWNWELL SYSTEM WITH SWELLABLE PACKER INCLUDING BLOWING AGENT

(76) Inventors: Jurgen Klunge, Nordrhein-Westpfahlen (DE); Bernd Jansen, Eschweiler (DE); Andreas Lutz, Nideggen (DE)

Correspondence Address: MYERS BIGEL SIBLEY & SAJOVEC, PO BOX 37428, RALEIGH, NC, 27627, US

(21) Appl. No.: 12/366,808

(22) Filed: Feb. 6, 2009

Related U.S. Application Data
(60) Provisional application No. 61/028,997, filed on Feb. 15, 2008.

(51) Int. Cl. E21B 33/12; C08F 251/02; C08F 253/00

(52) U.S. Cl. 166/179; 507/210; 507/230; 507/221; 507/214; 507/227

(57) ABSTRACT

A downwell packer assembly includes a tubular member and a packer element mounted on the tubular member. The packer element comprises a composition that includes a polymer. The packer element includes micropores (typically created via a blowing agent). When the packer element is exposed to a swelling fluid, such as water or hydrocarbon, the micropores can help to control and, in some instances, increase the rate of swelling. Such swelling enables the packer element to form a seal against the walls of the wellbore.

### RELATED APPLICATION

The present application claims priority from U.S. Provisional Patent Application Ser. No. 61/028,997, filed Feb. 15, 2008, the disclosure of which is hereby incorporated herein in its entirety.

### FIELD OF THE INVENTION

The present invention relates generally to a wellbore system for oil exploration, and more particularly to a packer for a wellbore system.

### BACKGROUND OF THE INVENTION

A downhole wellbore system typically includes a pipe or other tubular structure that extends into a borehole drilled into the ground. In some instances, a casing is inserted into the wellbore to define its outer surface; in other instances, the rock or soil itself serves as the wall of the wellbore.

Many wellbore systems include a packer, which is designed to expand radially outwardly from the pipe against the walls of the wellbore. The packer is intended to seal segments of the pipe against the wellbore in order to isolate some sections of the wellbore from others. For example, it may be desirable to isolate a section of the formation that includes recoverable petroleum product from an aquifer.

Known sealing members for packers include, for example, mechanical packers which are arranged in the borehole to seal an annular space between a wellbore casing and a production pipe extending into the borehole. Such a packer is radially deformable between a retracted position, in which the packer is lowered into the borehole, and an expanded position, in which the packer forms a seal. Activation of the packer can be by mechanical or hydraulic means. One limitation of the applicability of such packers is that the seal surfaces typically need to be well defined, and therefore their use may be limited to wellbores with casings. Also, they can be somewhat complicated and intricate in their construction and operation. An exemplary mechanical packer arrangement is discussed in U.S. Pat. No. 7,070,001 to Whanger et al., the disclosure of which is hereby incorporated herein in its entirety.

Another type of annular seal member is formed by a layer of cement arranged in an annular space between a wellbore casing and the borehole wall. Although in general cement provides adequate sealing capability, there are some inherent drawbacks such as shrinking of the cement during hardening, which can result in de-bonding of the cement sheath, or cracking of the cement layer after hardening.

Additional annular seal members for packers have been formed of swellable elastomers. These elastomers expand radially when exposed to an activating liquid, such as water (often saline) or hydrocarbon, that is present in the wellbore. Exemplary materials that swell in hydrocarbons include ethylene propylene rubber (EPM and EPDM), ethylene-propylene-diene terpolymer rubber (EPT), butyl rubber, brominated butyl rubber, chlorinated butyl rubber), chlorinated polyethylene, neoprene rubber, styrene butadiene copolymer rubber (SBR), sulphonated polyethylene, ethylene acrylate rubber, epichlorohydrin ethylene oxide copolymer, silicone rubbers and fluorsilicone rubber. Exemplary materials that swell in water include starch-polyacrylate acid graft copolymer, polyvinyl alcohol cyclic acid anhydride graft copolymer, isobutylene maleic anhydride, acrylic acid type polymers, vinylacetate-acrylate copolymer, polyethylene oxide polymers, carboxymethyl cellulose type polymers, starch-polyacrylonitrile graft copolymers and the like and highly swelling clay minerals such as sodium bentonite. Exemplary swellable packers are discussed in U.S. Pat. No. 7,059,415 to Bosma et al. and U.S. Patent Publication No. 2007/0056735 to Bosma et al., the disclosure of each of which is hereby incorporated herein in its entirety.

With packers that employ swellable systems, it can be difficult to control the timing and/or rate of expansion. As such, it may be desirable to provide a packer system in which a swellable packer is time-controlled.

### SUMMARY OF THE INVENTION

As a first aspect, embodiments of the present invention are directed to a downwell packer assembly. The packer assembly comprises a tubular member and a packer element mounted on the tubular member. The packer element comprises a composition that includes a polymer. The packer element includes micropores (typically created via a blowing agent). When the packer element is exposed to a swelling fluid, such as water or hydrocarbon, the micropores can help to control and, in some instances, increase the rate of swelling. Such swelling enables the packer element to form a seal against the walls of the wellbore.

As a second aspect, embodiments of the present invention are directed to a composition suitable for use in a packer element for a wellbore, comprising a swellable polymer and a blowing agent. Such a composition can provide a packer element with micropores as described above.

### BRIEF DESCRIPTION OF THE FIGURES

FIG. 1 is a partial section view of a downwell bore and pipe with a packer system according to embodiments of the present invention, wherein the packer element is in an unswelled condition.

FIG. 2 is a partial section view of the packer system of FIG. 1, wherein the packer element is in a swelled condition.

### DETAILED DESCRIPTION OF EMBODIMENTS OF THE INVENTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

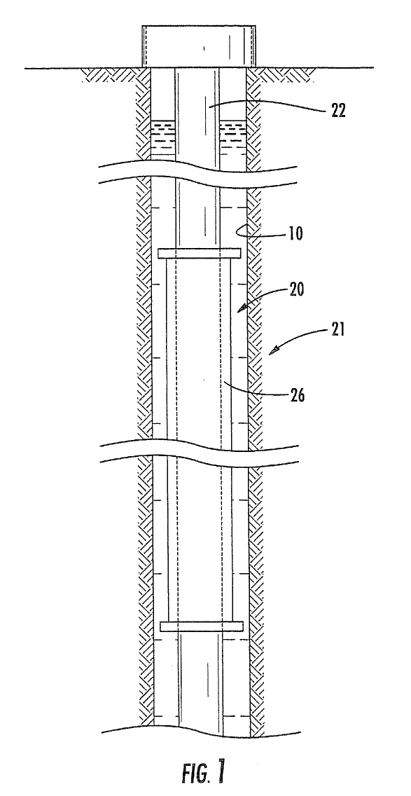

Turning now to the figures, a downwell pipe assembly, designated broadly at 20, is shown in FIG. 1. The assembly 20 is inserted into a wellbore 10, which is defined by walls in the earth. Although shown here disposed directly into the ground, in some embodiments the assembly 20 may be disposed within a casing or other annular member that is inserted in the earth. In addition, the wellbore 10 is illustrated herein as being substantially vertical, but may also be substantially horizontally disposed or disposed at any angle typically used for wells. As used herein, the term “wellbore” is intended to encompass either of these scenarios.

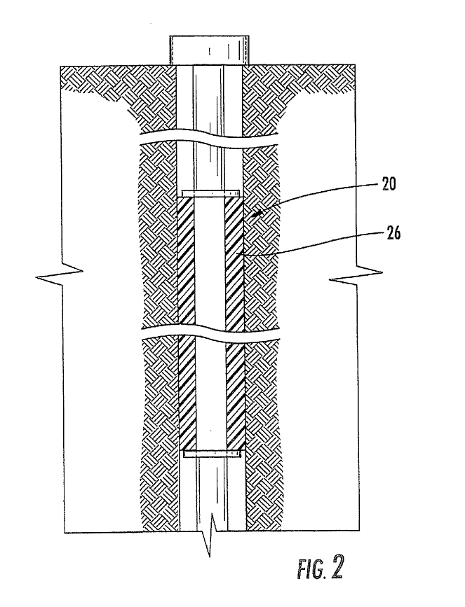

The assembly 20 includes a base pipe 22, which can be any pipe or tubular member typically employed in downwell environments, and a packer system 21. The packer system 21 includes one or more packer elements 26 (only one is shown herein). As shown in FIG. 1, the packer element 26 remains in an unswelled condition until it contacts a swelling fluid. FIG. 2 shows the packer element 26 in a swelled condition (i.e., after it has contacted the swelling fluid).

The packer element 26 is annular and circumferentially overlies the base pipe 22. The packer element 26 is formed of a polymeric material. The polymeric material includes micropores, which are typically formed with a blowing agent during formation of the packer element 26 (for example, during vulcanization). As used herein, the term “micropore” refers to pores, holes, passages, channels, and the like that are formed in the packer element that have a height/width dimension (e.g., a nominal diameter) of less than about 2 nm. The presence of the micropores in the packer element 26 can influence, and in some instances improve the control of, the swelling behavior of the packer element 26. Exemplary polymeric materials include nitrile rubber (NBR), hydrogenated nitrile rubber (HNBR), carboxylated nitrile rubber (XNBR), butyl rubber (BR), isobutylene isoprene rubber (IIR), EPDM, chloroprene rubber (CR), polyacrylate (ACM), chlorinated polyethylene (CSM), epichlorohydrin rubber (ECO), ethyl vinyl acetate (EVM), fluorocarbon rubber (FPM), polyurethane, and thermoplastic elastomers.

Exemplary blowing agents include NaHCO3 and 4,4′-oxy-bis(benzenesulfohydrazide), each of which activates in water. In some embodiments, the blowing agent is present in the composition in an amount of between about 0.1 and 4 percent by weight prior to vulcanization.

In some embodiments, the polymeric material of the packer element 26 is a swellable elastomer that swells in the presence of a swelling fluid. Typical swelling fluids include water and hydrocarbons, particularly in the form of crude oil. Exemplary elastomeric materials that swell in hydrocarbons include ethylene propylene rubber (EPM and EPDM), ethylene-propylene-diene terpolymer rubber (EPT), BR, brominated BR, chlorinated BR, CSM, neoprene rubber, styrene butadiene copolymer rubber (SBR), sulphonated polyethylene, ethylene acrylate rubber, epichlorohydrin ethylene oxide copolymer, silicone rubbers and fluorsilicone rubber. Exemplary elastomeric materials that swell in water include starch-polyacrylate acid graft copolymer, polyvinyl alcohol cyclic acid anhydride graft copolymer, isobutylene maleic anhydride, acrylic acid type polymers, vinylacetate-acrylate copolymer, polyethylene oxide polymers, carboxymethyl cellulose type polymers, starch-polyacrylonitrile graft copolymers and the like. In some embodiments, swelling agents, such as low molecular weight polymers like polyethylene, may be included.

The elastomer may also include fillers and additives that enhance its manufacturing or performance properties and/or reduce its costs. Exemplary filler materials include inorganic oxides such as aluminum oxide (Al₂O₃), silicon dioxide (SiO₂), magnesium oxide (MgO), calcium oxide (CaO), zinc oxide (ZnO) and titanium dioxide (TiO₂), carbon black (also known as furnace black), silicates such as clays, talc, wollastonite (CaSiO₃), magnesium silicate (MgSiO₃), anhydrous aluminum silicate, and feldspar (KAlSi₃O₈), sulfates such as barium sulfate and calcium sulfate, metallic powders such as aluminum, iron, copper, stainless steel, or nickel, carbonates such as calcium carbonate (CaCo₃) and magnesium carbonate (MgCo₃), mica, silica (natural, fumed, hydrated, anhydrous or precipitated), and nitrides and carbides, such as silicon carbide (SiC) and aluminum nitride (AlN). These fillers may be present in virtually any form, such as powder, pellet, fiber or sphere. Exemplary additives include polymerization initiators, activators and accelerators, curing or vulcanizing agents, plasticizers, heat stabilizers, antioxidants and antiozonants, coupling agents, pigments, and the like, that can facilitate processing and enhance physical properties.

Those skilled in this art will appreciate that the packer element may take other forms. For example, the packer element may be divided into multiple segments, any of which may include end caps to facilitate radial swelling and/or insertion of the packer assembly into the wellbore. The packer element may be covered with a protective layer that is removed prior to swelling. The thickness of the packer element may vary at different axial locations along the packer. Also, although the packer element described herein may be formed of material that swells in a swelling fluid, the packer element may be one element of an overall packer system that also includes elements that swell via hydraulic or mechanical means. Other variations may be apparent to those skilled in this art.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A composition suitable for use in a packer element for a wellbore, comprising:
a swellable polymer; and
a blowing agent.

2. The composition defined in claim 1, wherein the swellable polymer is a water-swellable polymer.

3. The composition defined in claim 2, wherein the water-swellable polymer is selected from the group consisting of: starch-polyacrylate acid graft copolymers; polyvinyl alcohol cyclic acid anhydride graft copolymers; isobutylene maleic anhydride; acrylic acid type polymers, vinylacetate-acrylate copolymers; polyethylene oxide polymers; carboxymethyl cellulose type polymers; and starch-polyacrylonitrile graft copolymers.

4. The composition defined in claim 2, wherein the blowing agent is a water-activated blowing agent.

5. The composition defined in claim 4, wherein the blowing agent is selected from the group consisting of: NaHCO3 and 4,4′-oxy-bis(benzenesulfohydrazide).

6. The composition defined in claim 1, wherein the swellable polymer is a hydrocarbon-swellable polymer.

7. The composition defined in claim 6, wherein the hydrocarbon-swellable polymer is selected from the group consisting of: ethylene propylene rubber, ethylene-propylene-diene terpolymer rubber, butadiene rubber, brominated butadiene rubber, chlorinated butadiene rubber, chlorinated polyethylene, neoprene rubber, styrene butadiene copolymer rubber, sulphonated polyethylene, ethylene acrylate rubber, epichlorohydrin ethylene oxide copolymer, silicone rubbers and fluorsilicone rubber.

8. The composition defined in claim 1, wherein the composition includes micropores.

9. The composition defined in claim 1, wherein the blowing agent is present in the swellable polymer in an amount of about 0.1 to 4 percent by weight.

10. A packer assembly, comprising:
a tubular member; and
a packer element mounted on the tubular member, the packer element comprising a composition that includes a polymer, the packer element including micropores.

11. The packer assembly defined in claim 10, wherein the polymer is a swellable polymer.

12. The packer assembly defined in claim 11, wherein the swellable polymer is a water-swellable polymer.

13. The packer assembly defined in claim 12, wherein the water-swellable polymer is selected from the group consisting of: starch-polyacrylate acid graft copolymers; polyvinyl alcohol cyclic acid anhydride graft copolymers; isobutylene maleic anhydride; acrylic acid type polymers, vinylacetate-acrylate copolymers; polyethylene oxide polymers; carboxymethyl cellulose type polymers; and starch-polyacrylonitrile graft copolymers.

14. The packer assembly defined in claim 10, wherein the composition further comprises a blowing agent.

15. The packer assembly defined in claim 14, wherein the blowing agent is a water-activated blowing agent.

16. The packer assembly defined in claim 14, wherein the blowing agent is present in the swellable polymer in an amount of about 0.1 to 4 percent by weight.

17. The packer assembly defined in claim 14, wherein the blowing agent is selected from the group consisting of: NaHCO3 and 4,4′-oxy-bis(benzenesulfohydrazide).

18. The packer assembly defined in claim 11, wherein the swellable polymer is a hydrocarbon-swellable polymer.

19. The packer assembly defined in claim 18, wherein the hydrocarbon-swellable polymer is selected from the group consisting of: ethylene propylene rubber, ethylene-propylene-diene terpolymer rubber, butadiene rubber, brominated butadiene rubber, chlorinated butadiene rubber, chlorinated polyethylene, neoprene rubber, styrene butadiene copolymer rubber, sulphonated polyethylene, ethylene acrylate rubber, epichlorohydrin ethylene oxide copolymer, silicone rubbers and fluorsilicone rubber.

20. The packer assembly defined in claim 10, wherein the micropores are formed during vulcanization.

21. A packer assembly, comprising:
a tubular member; and
a packer element mounted on the tubular member, the packer element comprising a composition that includes a swellable polymer, the packer element including micropores formed by a blowing agent.
